(19) United States
(12) Patent Application Publication
(10) Pub. No.: US 2010/0330934 A1
(43) Pub. Date: Dec. 30, 2010

(54) COMBINATION MODULE WITH ANTENNA AND AUDIO-COMPONENT

(75) Inventor: XIAO-HUI ZHANG, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/647,649

(22) Filed: Dec. 28, 2009

(30) Foreign Application Priority Data
Jun. 26, 2009 (CN) 200910303759.6

(51) Int. Cl. H04B 1/38

(52) U.S. Cl. 455/90.2

(57) ABSTRACT

A combination module includes an antenna, an audio component, a first carrier and a second carrier. The antenna is attached to the first carrier. The audio component is attached to the second carrier. The first carrier and the second carrier are integrally formed together.

### BACKGROUND

1. Technical Field

The present disclosure generally relates to antennas, particularly to a combination module with antenna and audio component for a portable wireless communication device.

2. Description of Related Art

Portable wireless communication devices generally include an antenna assembled therein to transmit and receive electromagnetic waves and audio components such as a speaker. However, the antenna and the audio components are independent components, and inevitably increase the size and cost of manufacturing portable wireless communication devices.

Therefore, there is room for improvement within the art.

### BRIEF DESCRIPTION OF THE DRAWINGS

Many aspects of the combination module can be better understood with reference to the following drawings. The components in the drawings are not necessarily drawn to scale, the emphasis instead being placed upon clearly illustrating the principles of the combination module and the portable wireless communication device.

FIG. 1 is a schematic view of a combination module with an antenna and an audio component, according to an exemplary embodiment.

FIG. 2 is an assembled view of the combination module of FIG. 1.

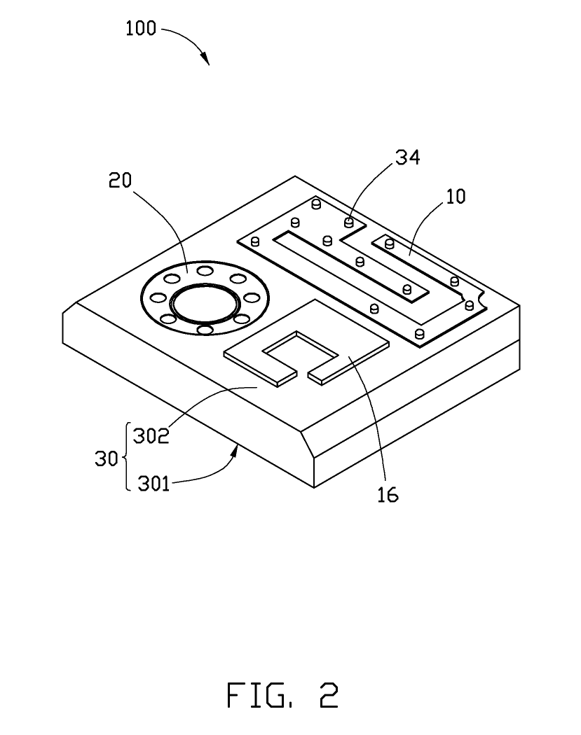

### DETAILED DESCRIPTION

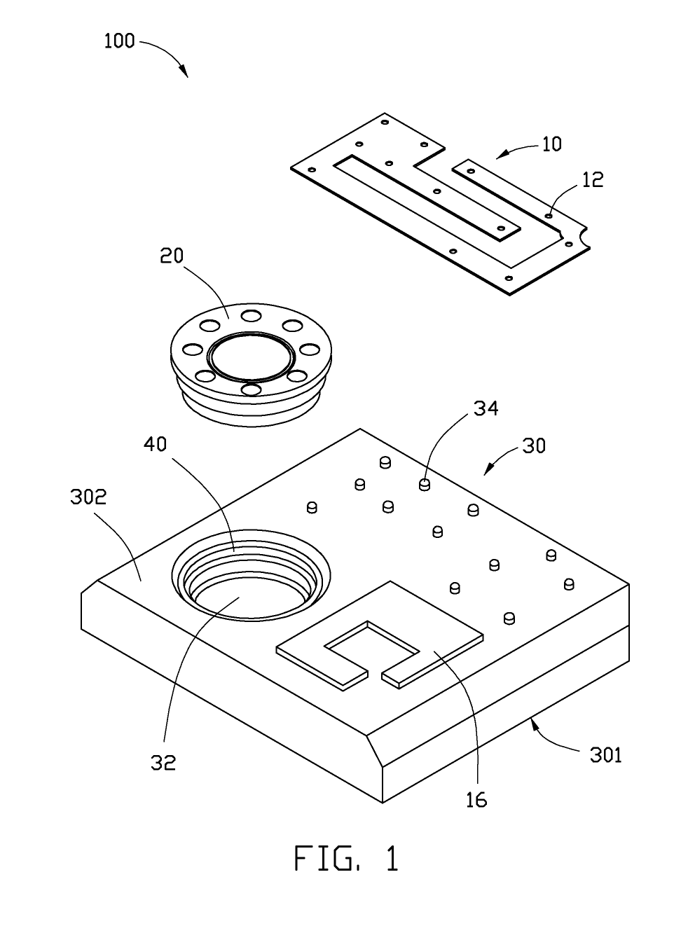

Referring to FIG. 1, a combination module 100 incorporating antenna and audio functions is used in a portable wireless communication device, such as a mobile phone terminal, digital camera etc.

The combination module 100 includes a first antenna unit 10, a second antenna unit 16, an audio component 20, an antenna carrier 30, and an audio component carrier 40. In this embodiment, the first antenna unit 10 is a conductive trace, preferably metallic, e.g. made from copper. The second antenna unit 12 is printed or etched out of a conductive layer on the antenna carrier 30. The conductive layer includes a macromolecule polymer and additive. The macromolecule polymer is selected from a group macromolecule polymer consisting of polyacetylene, polyphenylene sulfide (PPS), polypyrrole (PPY), polythiophene (PT) and polythiazole.

In the exemplary embodiment, the first antenna unit 10 is a lower frequency antenna and the second antenna 16 is a higher frequency antenna. The first antenna unit 10 and the second antenna unit 16 are spaced a predetermined distance apart. Thus, the first antenna unit 10 and the second antenna unit 16 may work together to resonate a wider predetermined working frequency range. In this embodiment, the first antenna unit 10 and the second antenna unit 16 are rectangular sheets with C-shaped cutout defined therein communicating with an outside edge of the rectangle. Size and arrangement of spaces formed by the cutouts may be varied according to radio frequency considerations as known to those skilled in the art.

The audio component is a speaker in this exemplary embodiment.

The antenna carrier 30 supports and fixes the antenna 10. The antenna carrier 30 can be made of an insulating resin material selected from a group consisting of polycarbonate (PC) and acrylonitrile-butadiene-styrene (ABS). The antenna carrier 30 includes a first surface 301 and a second surface 302. The first surface 301 is attached to a printed circuit board in the portable wireless communication device. The second surface 302 defines a receiving cavity 32 communicating with the first surface 301 of the antenna carrier 30. The second surface 302, adjacent to the second antenna unit 16, forms a plurality of posts 34 for being received in the holes 12 of the antenna 10.

The audio component carrier 40 has a shape for fixing the audio component 20, such as a stepped cylindrical sleeve shape. The antenna carrier 30 can be made of an insulating resin material selected from a group consisting of polycarbonate (PC) and acrylonitrile-butadiene-styrene (ABS). The audio component carrier 40 is fixed in the receiving cavity 32.

During assembly, the holes 12 of the first antenna unit 10 are placed around the posts 34 of the antenna carrier 30 to fix the first antenna unit 10 to the antenna carrier 30. The audio component carrier 40 is fixed in the receiving cavity 32. The frequency audio component 20 is attached to the audio component carrier 40. Thus, the first antenna unit 10, the second antenna unit 16, and the frequency audio component 20 are all fixed to the antenna carrier 30.

An exemplary embodiment of a method for making the antenna module 100 may comprise the following steps:

An injection molding machine is provided. The insulating resin is injected into a mold of the injection molding machine to form the antenna carrier 30 and the carrier 40. The antenna carrier 30 forms a plurality of posts 34. Then, the second antenna unit 16 is printed on the antenna carrier 30. After that, the first antenna unit 10 is secured on the antenna carrier 30 with higher precision of orientation, thereby improving call performance of the portable electronic devices.

It is to be understood, that the first antenna unit 10 and the second antenna unit 16 are directly attached to the antenna carrier 30 during and by the molding process, thereby improving production efficiency.

The first antenna unit 10 and the second antenna unit 16 are made achieve two or more working frequency ranges. Furthermore, the combination module 100 not only provides an antenna function, but also provides an audio function.

It is believed that the exemplary embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A combination module comprising:
a first antenna unit;
a second antenna unit;
an audio component;
a first carrier, the first antenna unit and the second antenna unit attached to the first carrier; and
a second carrier, the audio component attached to the second carrier, wherein the first carrier and the second carrier are integrally formed together.

2. The combination module as claimed in claim 1, wherein the first antenna unit defines a plurality of holes, the first carrier forms a plurality of posts, and the posts are received in the holes configured for fixing the first antenna unit to the first carrier.

3. The combination module as claimed in claim 2, wherein the second antenna unit is printed on the first carrier.

4. The combination module as claimed in claim 2, wherein the second antenna unit is etched out of a conductive layer on the first carrier.

5. A portable wireless communication device, comprising:
a first carrier including a first surface and a second surface opposite to the first surface;
a second carrier integrally formed in the first carrier;
an audio component fixed in the second carrier; and
an antenna mounted on the first carrier, the antenna comprising:
a first antenna unit; and
a second antenna unit spaced from the first antenna unit.

6. The portable wireless communication device as claimed in claim 5, wherein the first antenna unit defines a plurality of holes, the first carrier forms a plurality of posts, and the posts are received in the holes configured for fixing the first antenna unit to the first carrier.

7. The portable wireless communication device as claimed in claim 5, wherein the second antenna unit is printed on the first carrier.

8. A combination module comprising:
an antenna;
an audio component;
a carrier, the antenna and the audio component disposed to the carrier.

9. The combination module as claimed in claim 8, wherein the carrier includes a first carrier and a second carrier, the antenna is fixed in the first carrier, the audio component is fixed in the second carrier, and the first carrier and a second carrier are integrally formed together.

10. The combination module as claimed in claim 8, wherein the antenna includes a first antenna unit and a second antenna unit spaced from the first antenna unit.

11. The combination module as claimed in claim 10, wherein the first antenna unit defines a plurality of holes, the carrier forms a plurality of posts, and the posts are received in the holes configured for fixing the first antenna unit to the carrier.
